(19) United States
(12) Patent Application Publication
(10) Pub. No.: US 2009/0197119 A1
(43) Pub. Date: Aug. 6, 2009

(54) PERPENDICULAR MAGNETIC RECORDING MEDIUM

(75) Inventors: Sok-hyun KONG, Seoul (KR); Seong-yong YOON, Suwon-si (KR); Hoo-san LEE, Osan-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/137,318

(22) Filed: Jun. 11, 2008

(30) Foreign Application Priority Data
Feb. 1, 2008 (KR) 10-2008-0010822

(51) Int. Cl. G11B 5/62

(52) U.S. Cl. 428/800

(57) ABSTRACT

Provided is a perpendicular magnetic recording medium. The perpendicular magnetic recording medium includes: a substrate; a plurality of soft magnetic layers including a lower soft magnetic layer and an upper soft magnetic layer which are sequentially stacked on the substrate, wherein the upper soft magnetic layer has an anisotropic field greater than that of the lower soft magnetic layer; an isolating layer interposed between the lower and upper soft magnetic layers and preventing magnetic interaction between the lower and upper soft magnetic layers; an underlayer formed on the plurality of soft magnetic layers; and a recording layer formed on the underlayer and including a plurality of ferromagnetic layers each layer of which has a magnetic anisotropic energy which decreases as distance increases from the underlayer.

### CROSS-REFERENCE TO RELATED PATENT APPLICATION

This application claims priority from Korean Patent Application No. 10-2008-0010822, filed on Feb. 1, 2008, in the Korean Intellectual Property Office, the disclosure of which is incorporated herein by reference in its entirety.

### BACKGROUND OF THE INVENTION

1. Field of the Invention

The present invention relates to a perpendicular magnetic recording medium, and more particularly, to a perpendicular magnetic recording medium that can record and reproduce information in high density.

2. Description of the Related Art

With the rapid increase in the amount of data, the demands for higher density data storage devices for recording and reproducing data have increased. In particular, since magnetic recording devices employing a magnetic recording medium have high storage capacity and high speed access, they have attracted much attention as data storage devices for various digital devices as well as computer systems.

Data recording for magnetic recording devices can be roughly classified into longitudinal magnetic recording and perpendicular magnetic recording. In longitudinal magnetic recording, data is recorded using the parallel alignment of the magnetization of a magnetic layer on a surface of the magnetic layer. In perpendicular magnetic recording, data is recorded using the perpendicular alignment of a magnetic layer on a surface of the magnetic layer. From the perspective of data recording density, perpendicular magnetic recording is more advantageous than longitudinal magnetic recording.

Perpendicular magnetic recording media have a three-layer structure including a soft magnetic underlayer forming the magnetic path of a recording magnetic field, a recording layer magnetized in a direction perpendicular to a surface of the magnetic recording media by the recording magnetic field, and an intermediate layer controlling the crystal orientation of the recording layer.

In order to achieve high density recording, perpendicular magnetic recording media must have a high coercive force and perpendicular magnetic anisotropic energy for a recording layer to secure the stability of recorded data, a small grain size, and a small magnetic domain size due to a low exchange coupling constant between grains. An exchange coupling constant indicates the strength of magnetic interaction between the grains in the recording layer. As the exchange coupling constant decreases, it becomes easier to decouple the grains. In order to manufacture such high density perpendicular magnetic recording media, a technology for maximizing the magnetic anisotropic energy Ku and perpendicular crystal orientation of the recording layer is needed.

Also, when the recording layer is formed of a material having a high magnetic anisotropic energy Ku, the coercive force of the recording layer is increased and a strong writing field is necessary during writing operations. The perpendicular magnetic recording media requires a soft magnetic layer that can sufficiently attract the strong writing field and form a magnetic path. Accordingly, a soft magnetic layer having a high permeability is demanded.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a perpendicular magnetic recording medium that can increase the magnetic anisotropic energy Ku of a recording layer, clearly separate fine grains in the recording layer, improve crystal orientation, and include a soft magnetic layer that can improve recording characteristics of the recording layer with the increased magnetic anisotropic energy Ku.

According to an aspect of the present invention, there is provided a perpendicular magnetic recording medium comprising: a substrate; a plurality of soft magnetic layers comprising a lower soft magnetic layer and an upper soft magnetic layer which are sequentially stacked on the substrate, wherein the upper soft magnetic layer has an anisotropic field greater than that of the lower soft magnetic layer; an isolating layer interposed between the lower and upper soft magnetic layers and preventing magnetic interaction between the lower and upper soft magnetic layers; an underlayer formed on the plurality of soft magnetic layers; and a recording layer formed on the underlayer and comprising a plurality of ferromagnetic layers each layer of which has a magnetic anisotropic energy which decreases as distance increases from the underlayer.

Each layer of the plurality of ferromagnetic layers may have a Pt concentration which decreases as distance increases from the underlayer.

The plurality of ferromagnetic layers comprise first and second ferromagnetic layers sequentially stacked on the underlayer. The first ferromagnetic layer may have a larger distance between atoms in a crystal plane parallel to the substrate than the second ferromagnetic layer.

The first ferromagnetic layer may be formed of any one selected from the group consisting of an FePt alloy, an FePt alloy oxide, a CoPt alloy, and a CoPt alloy oxide, and the second ferromagnetic layer may be formed of a CoCrPt alloy oxide. The second ferromagnetic layer may have a Pt concentration less than that of the first ferromagnetic layer.

The underlayer may be formed of Ru and oxygen.

The underlayer may comprise a first underlayer formed of Ru and a second underlayer formed of Ru and oxygen on the first underlayer, wherein grains contained in the second underlayer are formed of Ru and oxygen is interposed between the grains.

The isolating layer may be formed of a non-magnetic metal material or a non-magnetic non-metal material.

The upper soft magnetic layer may comprise: a plurality of unit soft magnetic layers; and at least one non-magnetic spacer interposed between the plurality of unit soft magnetic layers, so as to form an Ruderman-Kittel-Kasuya-Yosida (RKKY) coupling structure.

The perpendicular magnetic recording medium may further comprise a magnetic domain control layer disposed under the upper soft magnetic layer so that the upper soft magnetic layer has a high anisotropic field.

The magnetic domain control layer may be formed of an antiferromagnetic material or a ferromagnetic material.

The upper soft magnetic layer may be thinner than the lower soft magnetic layer.

### BRIEF DESCRIPTION OF THE DRAWINGS

The above and other aspects of the present invention will become more apparent by describing in detail exemplary embodiments thereof with reference to the attached drawings in which:

FIG. 1 is a cross-sectional view of a perpendicular magnetic recording medium according to an exemplary embodiment of the present invention;

FIGS. 2 and 3 are cross-sectional views for explaining the function of a soft magnetic layer of the perpendicular magnetic recording medium of FIG. 1;

FIGS. 4 through 6 are cross-sectional views illustrating modifications of the perpendicular magnetic recording medium of FIG. 1;

FIG. 7 is a cross-sectional view of a recording layer of the perpendicular magnetic recording medium of FIG. 1 according to an exemplary embodiment of the present invention;

FIG. 8 is a transmission electron microscopy (TEM) image of an underlayer of the perpendicular magnetic recording medium of FIG. 1;

FIG. 9 is a TEM image of a recording layer of the perpendicular magnetic recording medium of FIG. 1;

FIGS. 10 and 11 are graphs illustrating magnetic characteristics when Co alloy oxide layers of a recording layer are stacked in different orders; and

FIGS. 12A and 12B are graphs illustrating X-ray diffraction (XRD) analysis results when Co alloy oxide layers of a recording layer are stacked in different orders.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather these exemplary embodiments are provided so that this disclosure will be thorough and complete, and will fully convey the concept of the invention to those skilled in the art. In the drawings, the same reference numeral denotes the same element and the thicknesses of elements may be exaggerated for clarity and convenience.

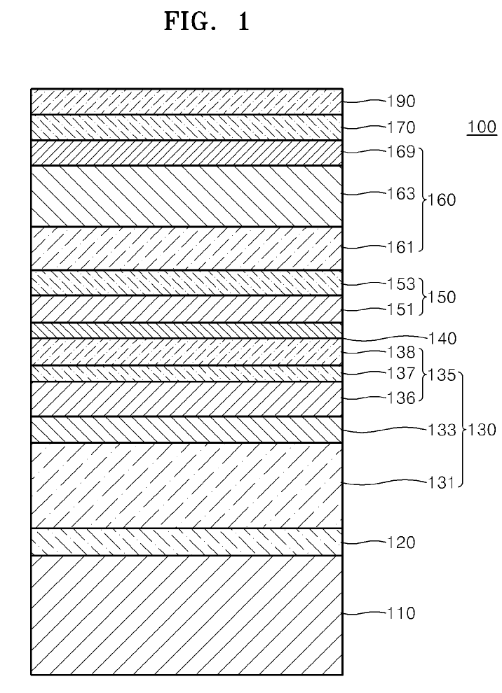

FIG. 1 is a cross-sectional view of a perpendicular magnetic recording medium 100 according to an exemplary embodiment of the present invention.

Referring to FIG. 1, the perpendicular magnetic recording medium 100 is formed by sequentially stacking a substrate 110, a soft magnetic layer 130, an underlayer 150, a recording layer 160, a protective layer 170, and a lubricating layer 190.

The substrate 110 may be formed of glass or an AlMg alloy, and may have a disk shape.

The protective layer 170 is provided to protect the recording layer 160 from the outside and may be formed of diamond-like carbon (DLC). The lubricating layer 190 may be formed on the protective layer 170 to reduce the abrasion of a magnetic head and the protective layer 170 due to collision with and sliding of the magnetic head. The lubricating layer 190 may be formed of tetraol.

Buffer layers 120 and 140 may be respectively interposed between the substrate 110 and the soft magnetic layer 130 and between the soft magnetic layer 130 and the underlayer 150. The buffer layers 120 and 140 may be formed by stacking layers of Ti or Ta to several nanometers (nm). The buffer layers 120 and 140 suppress magnetic interaction between the substrate 110 and the soft magnetic layer 130 and between the soft magnetic layer 130 and the recording layer 160.

The soft magnetic layer 130 forms a magnetic path of a writing field generated from the write head during magnetic recording operations such that information can be written to the recording layer 160. The soft magnetic layer 130 has a double-layer structure including a lower soft magnetic layer 131 and an upper soft magnetic layer 135. The side of the substrate 110 on which the other layers are stacked is referred to an upper side and the opposite side of the substrate 110 is referred to as a lower side.

The upper soft magnetic layer 135 has an anisotropic field Hk greater than that of the lower soft magnetic layer 131. The lower soft magnetic layer 131 and the upper soft magnetic layer 135 are magnetically separated from each other. The lower and upper soft magnetic layers 131 and 135 are magnetized so that a magnetization easy axis is formed in a cross-track direction of the perpendicular magnetic recording medium 100.

An isolating layer 133 is interposed between the lower and upper soft magnetic layers 131 and 135 to magnetically separate the lower and upper soft magnetic layers 131 and 135. The isolating layer 133 may be formed of a non-magnetic metal material, such as Ta or Ti, or a non-magnetic non-metal material. The isolating layer 133 may have a thickness of several nanometers (nm) or more and prevents magnetic interaction between the lower and upper soft magnetic layers 131 and 135.

The lower soft magnetic layer 131 may be thicker than the upper soft magnetic layer 135 so that the lower soft magnetic layer 131 can effectively attract a writing field generated from the magnetic head and form a magnetic path of the writing field. The lower soft magnetic layer 131 may have a thickness of approximately 10 to 100 nm, and the upper soft magnetic layer 135 may have a thickness of approximately 1 to 20 nm.

The lower soft magnetic layer 131 may be formed of any one selected from the group consisting of a NiFe alloy, CoZrNb, CoZrTa, a FeTa alloy, and a FeCo alloy, and the upper soft magnetic layer 135 may be formed of any one selected from the group consisting of CoZrNb, CoZrTa, a FeTa alloy, and a FeCo alloy.

In order for the upper soft magnetic layer 135 to have an anisotropic field Hk greater than that of the lower soft magnetic layer 131, the upper soft magnetic layer 135 may have a Ruderman-Kittel-Kasuya-Yosida (RKKY) coupling structure. That is, the upper soft magnetic layer 135 may include first and second unit soft magnetic layers 136 and 138 and a spacer 137 interposed between the first and second unit soft magnetic layers 136 and 138. The RKKY coupling structure refers to a structure in which magnetic bodies are antiferromagnetically coupled to each other with a non-magnetic metal layer therebetween. In order to antiferromagnetically couple the first and second unit soft magnetic layers 136 and 138, the spacer 137 may be formed of a non-magnetic material, such as Ru, to a thickness of less than 2 nm, for example, approximately 0.8 nm. In order to prevent a domain wall, which causes a noise, from being created, it may be preferable that the upper soft magnetic layer 135 has a high anisotropic field Hk. The high anisotropic field Hk can be obtained by adjusting thicknesses of the first and second unit soft magnetic layers 136 and 138. For example, each of the first and second unit soft magnetic layers 136 and 138 may have a thickness of approximately 5 nm or less.

Since the upper soft magnetic layer 135 has the RKKY coupling structure, the anisotropic field Hk of the upper soft magnetic layer 135 can be greater than that of the lower soft magnetic layer 131 even though the lower and upper soft magnetic layers 131 and 135 are formed of the same material.

Since the anisotropic field Hk of the upper soft magnetic layer 135 is greater than that of the lower soft magnetic layer 131 and the lower and upper soft magnetic layers 131 and 135 are magnetically separated from each other, the lower soft magnetic layer 131 can effectively attract a writing field generated from the write head during writing operations and the upper soft magnetic layer 131 can effectively suppress a stray field during reading operations.

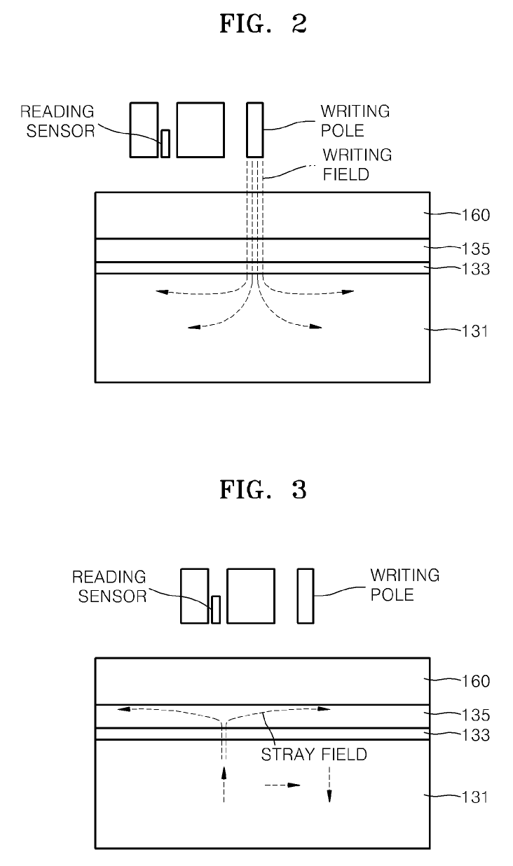

The function of the soft magnetic layer 130 of FIG. 1 will now be explained with reference to FIGS. 2 and 3. For convenience, only the lower and upper soft magnetic layers 131 and 135, the isolating layer 133, and the recording layer 160 of the perpendicular magnetic recording medium 100 are shown in FIGS. 2 and 3.

Referring to FIG. 2, when the lower soft magnetic layer 131 has a low anisotropic field Hk, the lower soft magnetic layer 131 can effectively attract a writing field generated from the write head during magnetic recording operations, and thus the writing field can be concentrated on the recording layer 160. That is, during writing operations, since the lower soft magnetic layer 131 is magnetized in a magnetization hard axis in a write mode, a writing field produced by a writing pole of the head passes through the recording layer 160 and the soft magnetic layer 130, and enters a return pole of the head. Accordingly, since the lower soft magnetic layer 131 has the low anisotropic field Hk, a high permeability can be ensured and the magnetic flux density of the writing field passing through the recording layer 160 can be high. Since the lower soft magnetic layer 131 having the high permeability can increase the intensity of the writing field, overwriting characteristics, which may be deteriorated when the magnetic anisotropic energy Hk of the recording layer 160 is increased, can be improved as will be described later.

Referring to FIG. 3, when the upper soft magnetic layer 135 has a high anisotropic field Hk, a stray field which may be generated at the lower soft magnetic layer 131 during reading operations spreads to the upper soft magnetic layer 135 and can be prevented from causing a noise in the recording layer 160 disposed on the upper soft magnetic layer 135. That is, when the lower soft magnetic layer 131 has a low anisotropic field Hk to have a high permeability, a magnetic domain structure is unstable, and thus a stray field is generated at the lower soft magnetic layer 131. The stray field generated at the lower soft magnetic layer 131 flows along a magnetization hard axis of the upper soft magnetic layer 135 during reading operations, thereby preventing the stray field from being sensed by a reading sensor of the head.

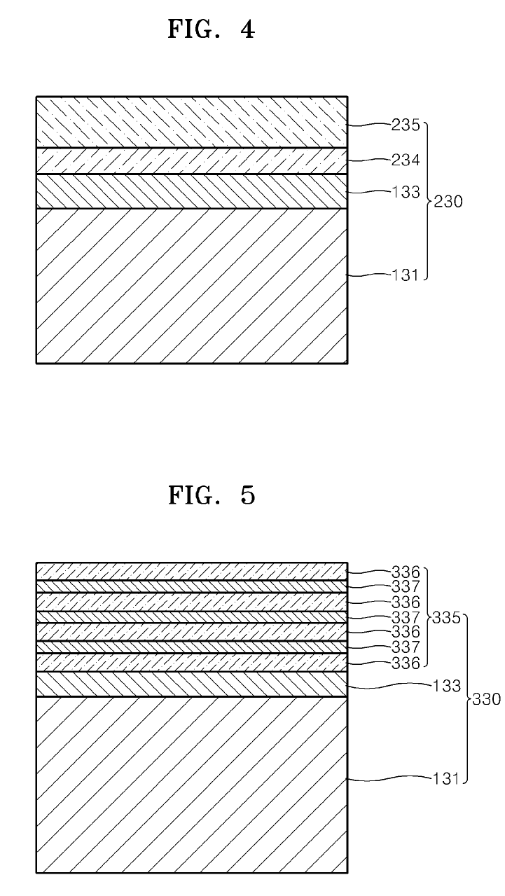

The soft magnetic layer 130 of FIG. 1 has a structure in which the anisotropic field Hk of the upper soft magnetic layer 135 is greater than that of the lower soft magnetic layer 131 and the lower and upper soft magnetic layers 131 and 135 are magnetically separated from each other. Although the upper soft magnetic layer 135 has the RKKY coupling structure in FIG. 1, the present invention is not limited thereto and various structures may be suggested. Modifications of the soft magnetic layer 130 will now be explained with reference to FIGS. 4 through 6.

FIG. 4 is a cross-sectional view illustrating a soft magnetic layer 230 including a magnetic domain layer 234 in order to have a high anisotropic field Hk. Referring to FIG. 4, the soft magnetic layer 230 may include an isolating layer 133 and the magnetic control layer 234 interposed between a lower soft magnetic layer 131 and an upper soft magnetic layer 235. The lower soft magnetic layer 131 and the isolating layer 133 of FIG. 4 are the same as those of FIG. 1, and thus a detailed explanation thereof will not be given.

The magnetic domain control layer 234, which controls a magnetic domain of the upper soft magnetic layer 235, may be formed of an antiferromagnetic material, such as IrMn, or a ferromagnetic material. That is, the magnetic domain control layer 234 may be antiferromagnetically or ferromagnetically coupled to the upper soft magnetic layer 235 so that the upper soft magnetic layer 235 has a high anisotropic field Hk.

In order to achieve stable crystal orientation of the magnetic domain control layer 234, an underlayer (not shown) may be interposed between the magnetic domain control layer 234 and the isolating layer 133, or the isolating layer 133 may serve as an underlayer.

FIG. 5 is a cross-sectional view illustrating a soft magnetic layer 330 including an upper soft magnetic layer 335 having a multi-layer structure in order to have a high anisotropic field Hk. Referring to FIG. 5, the soft magnetic layer 330 includes a lower soft magnetic layer 131, an isolating layer 133, and the upper soft magnetic layer 335. The lower soft magnetic layer 131 and the isolating layer 133 of FIG. 5 are the same as those of FIG. 1, and a detailed explanation thereof will not be given.

Since the upper soft magnetic layer 335 has the multi-layer structure, the upper soft magnetic layer 335 has a strong anisotropic field Hk. The upper soft magnetic layer 335 may include a plurality of unit soft magnetic layers 336 and a plurality of non-magnetic spacers 337 interposed between the unit soft magnetic layers 336. The unit soft magnetic layers 336 are substantially the same as the first and second unit soft magnetic layers 136 and 138 of FIG. 1, and the non-magnetic spacers 337 are substantially the same as the spacer 137 of FIG. 1. Since the soft magnetic layers 336 are strongly magnetically coupled with the non-magnetic spacers 337 therebetween, a magnetic wall can be prevented from being created while maintaining a high permeability, thereby improving noise removal effect.

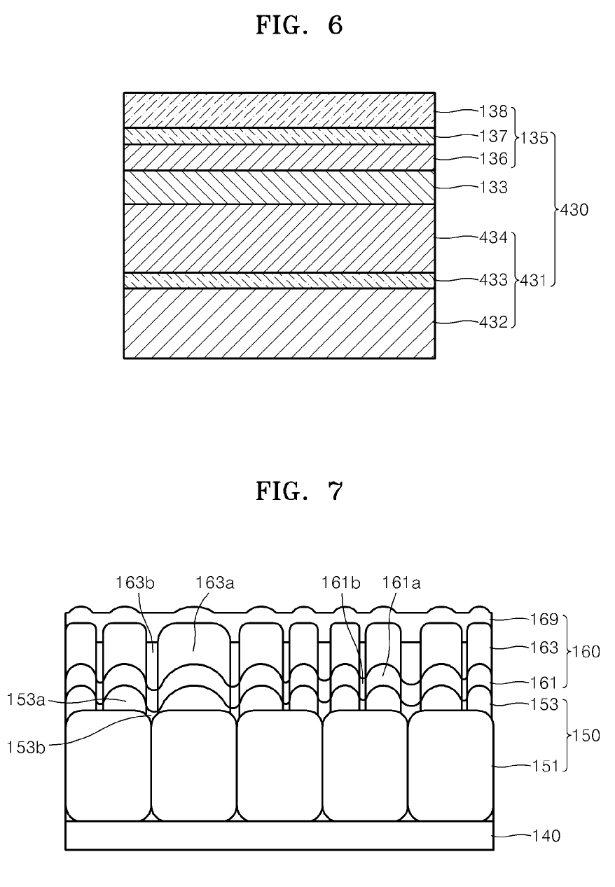

FIG. 6 is a cross-sectional view illustrating a soft magnetic layer 430 including a lower soft magnetic layer 431 having an RKKY coupling structure. The soft magnetic layer 430 further includes an isolating layer 133, and an upper soft magnetic layer 135. The isolating layer 133 and the upper soft magnetic layer 135 are the same as those of FIG. 1, and a detailed explanation thereof will not be given.

The lower soft magnetic layer 431 may be structured such that a spacer 433 is sandwiched between third and fourth unit soft magnetic layers 432 and 434. In order for the third and fourth unit soft magnetic layers 432 and 434 to be antiferromagnetically coupled to each other, the spacer 433 may be formed of a non-magnetic material, such as Ru, to a thickness of less than 2 nm, for example, approximately 0.8 nm. In order for the lower soft magnetic layer 431 to have a high permeability, each of the third and fourth unit soft magnetic layers 432 and 434 of the lower soft magnetic layer 431 may have a thickness of 10 nm or more. Since the third and fourth unit soft magnetic layers 432 and 434 are strongly magnetically coupled to each other with the non-magnetic spacer 433 therebetween, a magnetic wall can be prevented from being created while maintaining a high permeability, thereby improving noise removal effect.

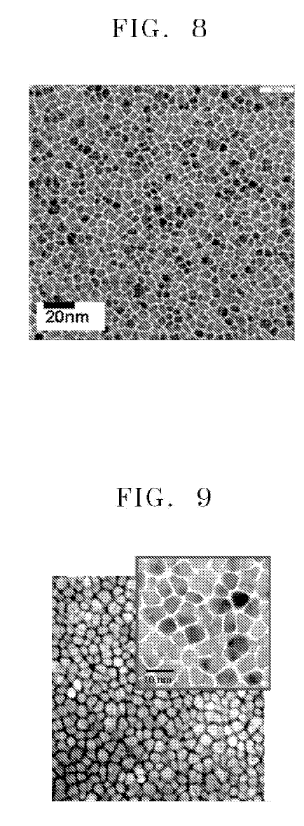

FIG. 7 is a cross-sectional view of the underlayer 150 and the recording layer 160 of the perpendicular magnetic recording medium 100 of FIG. 1 according to an exemplary embodiment of the present invention.

Referring to FIGS. 1 and 7, the underlayer 150, which improves the crystal orientation and magnetic characteristics of the recording layer 160, has a double-layer structure including a first underlayer 151 formed of Ru and a second underlayer 153 formed of Ru and an oxide. The second underlayer 153 may be thinner than the first underlayer 151. The first underlayer 151 improves the crystal orientation of the recording layer 160, and adjusts the grain size of the recording layer 160 by controlling the grain size of the second underlayer 153 to be small and uniform. Each of the first and second underlayers 151 and 153 has a granular structure. In particular, the second underlayer 153 has boundary zones 153b formed of an oxide and interposed between grains 153a formed of Ru. To this end, the second underlayer including Ru and an oxide is formed by oxygen reactive sputtering at an atmosphere having gas including an oxygen concentration of 0.1 to 5%.

For example, the first underlayer 151 may be formed using a Ru target by sputtering at room temperature at a pressure of 10 mTorr or less to a thickness of approximately 10 nm. The second underlayer 153 may be formed on the first underlayer 151 by reactive sputtering in which argon gas and oxygen gas are introduced at a pressure of 40 mTorr to a thickness of approximately 8 nm. The surface roughness of the second underlayer 153 is increased above that of the first underlayer 151, and the grains 153a are separated. FIG. 8 is a transmission electron microscopy (TEM) image of the second underlayer 153 that is formed by sputtering at an atmosphere having an oxygen concentration of 1%. Referring to FIG. 8, the grains 153a of the second underlayer 153 are finely formed and the boundary zones 153b include oxygen, such that the grains 153a are clearly separated from one another. The grains 153a formed of Ru have an average size of 5.4 nm.

Although the first underlayer 151 is formed of Ru in FIG. 1, the present invention is not limited thereto. The first underlayer 151 may be formed of Ru and an oxide. Furthermore, although the underlayer 150 has a double-layer structure in FIG. 1, the present invention is not limited thereto. However, in order to ensure a small and uniform grain size for the recording layer 160, it may be preferable that oxygen-containing Ru be deposited on at least an upper portion of the underlayer 150.

The recording layer 160 has a three-layer structure including a first ferromagnetic layer 161, a second ferromagnetic layer 163, and a capping layer 169 which are sequentially stacked on the underlayer 150.

The magnetic anisotropic energy Ku of the first ferromagnetic layer 161 is greater than that of the second ferromagnetic layer 163. The first ferromagnetic layer 161 may be formed of a CoPt alloy oxide having a high magnetic anisotropic energy Ku. The magnetic anisotropic energy of the first ferromagnetic layer 161 may range from 5×106 to 5×107 erg/cc. For example, when the first ferromagnetic layer 161 is formed of a CoPt oxide, such as CoPt—SiO2 or CoPt—TiO2, the CoPt oxide may have a Pt concentration of 10 to 50 at %. The second ferromagnetic layer 163 may be formed of a CoCrPt oxide having a low magnetic anisotropic energy Ku such as CoCrPt—SiO2. The magnetic anisotropic energy Ku of the second ferromagnetic layer 163 may range from 1×106 to 5×106 erg/cc and the second ferromagnetic layer 163 may have a Pt concentration of 1 to 30 at %. The Pt concentration of the first ferromagnetic layer 161 is greater than that of the second ferromagnetic layer 163.

The first and second ferromagnetic layers 161 and 163 have granular structures in which grains 161a and 163a are isolated from one another by boundary zones 161b and 163b, respectively. The grains 161a and 163a are formed of a Co alloy, and the boundary zones 161b and 163b between the grains 161 and 163b are formed of an oxide.

The capping layer 169 is formed on the first and second ferromagnetic layers 161 and 163 in order to improve writing characteristics. The capping layer 169 reduces a magnetization saturation field Hs of the first and second ferromagnetic layers 161 and 163, and thus the first and second ferromagnetic layers 161 and 163 can be easily magnetized despite a high magnetic anisotropic energy Ku, thereby improving writing characteristics. Furthermore, the capping layer 169 thermally stabilizes the first and second ferromagnetic layers 161 and 163. The capping layer 169 may be formed of a Co alloy having no oxygen, such as CoCrPtB. Accordingly, the capping layer 169 can be formed as a continuous thin film where grains are not separated by an oxide. However, the capping layer 169 is not limited to the continuous thin film, and may have a granular structure.

The recording layer 160 may be formed on the underlayer 150 having the double-layer structure formed of Ru and Ru-oxide by sputtering to have such a multi-layer structure, e.g., a CoCoPt—TiO2/CoCrPt—SiO2/CoCrPtB structure. For example, the first ferromagnetic layer 161 formed of CoPt—TiO2 may be formed using a CoPt—TiO2 target at a Pt-rich atmosphere at a high pressure of 40 mTorr or more to a thickness of approximately 10 nm. The second ferromagnetic layer 163 formed of CoCrPt—SiO2 may be formed using a CoCrPt—SiO2 target by reactive sputtering in which argon gas and oxygen gas are introduced at room temperature. Total gas used in the reactive sputtering has an oxygen concentration of 0.1% to 10%. The second ferromagnetic layer 163 formed of CoCrPt—SiO2 may be formed to a thickness of approximately 10 nm at a pressure 20 mTorr by increasing a sputtering power and decreasing a pressure to reduce the surface roughness of the first ferromagnetic layer 161 formed of CoPt—TiO2. The capping layer 169 formed of CoCrPtB may be formed as a continuous thin film to a thickness of approximately 5 nm at a pressure of 10 mTorr. The grains 161a contained in the first ferromagnetic layer 161 formed of CoPt—TiO2 are formed of CoPt and the boundary zones 161b surrounding the grains 161a are formed of TiO2. The grains 163a contained in the second ferromagnetic layer 163 formed of CoCrPt—SiO2 are formed of CoCrPt and the boundary zones 163b surrounding the grains 163a are formed of SiO2.

FIG. 9 is a TEM image of the recording layer 160 having the CoPt—TiO2/CoCrPt—SiO2/CoCrPtB structure according to an exemplary embodiment of the present invention. Referring to FIGS. 8 and 9, the grains 161a and 163a of the recording layer 160 have an average size of 5.7 nm and are clearly separated from one another. This seems to be because the well-isolated grains 153a of the underlayer 150 affect the recording layer 160 and improve the granular structure of the recording layer 160.

It is known that, in the case of a CoCrPt magnetic layer, a magnetic anisotropic energy Ku increases as a Pt concentration increases. When Cr is removed from the CoCrPt magnetic layer and a Pt concentration increases to 10 to 50 at %, preferably, to 20 to 30 at %, the magnetic anisotropic energy Ku of the magnetic layer can increase up to 5×107 erg/cc. However, once Cr is removed, it becomes harder to decouple grains. Accordingly, the underlayer 150 for improving crystal orientation is formed of Ru and oxygen, the first ferromagnetic layer 161 disposed on the underlayer 150 is formed of a CoPt oxide, and the second ferromagnetic layer 163 disposed on the first ferromagnetic layer 161 is formed of a CoCrPt oxide, so as to easily separate the grains 161a and 163a contained in the first and second ferromagnetic layers 161 and 163.

When the first ferromagnetic layer 161 has a surface roughness greater than that of the second ferromagnetic layer 163 disposed on the first ferromagnetic layer 161, flying conditions of the head can be improved. To this end, for example, when the first and second ferromagnetic layers 161 and 163 are used as sputters, the recording layer 160 is deposited with a higher power and a lower gas pressure than those applied to the first ferromagnetic layer 161, thereby reducing the surface roughness of the second ferromagnetic layer 163.

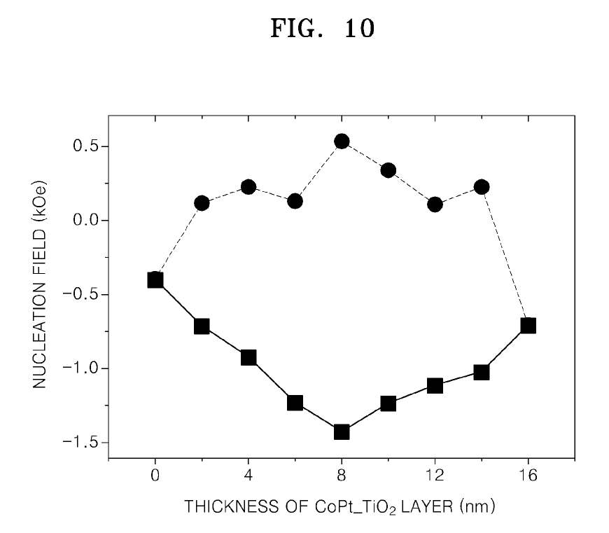

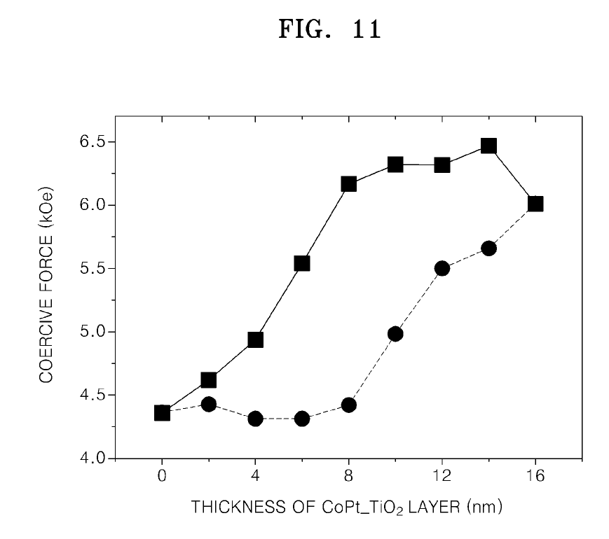

FIGS. 10 and 11 are graphs illustrating magnetic characteristics when Co ally oxide layers are stacked in different orders. In FIGS. 10 and 11, a solid line represents a present example in which a recording layer is formed by sequentially stacking a CoPt—TiO2 layer, a CoCrPt—SiO2 layer, and a CoCrPtB layer, and a dotted line represents a comparative example in which a recording layer is formed by sequentially stacking a CoCrPt—SiO2 layer, a CoPt—TiO2 layer, and a CoCrPtB layer. The total thickness of the CoCrPt—SiO2 layer and the CoPt—TiO2 layer was fixed to 16 nm. The CoCrPtB layer corresponds to a capping layer.

Referring to FIGS. 10 and 11, in the case of the comparative example in which the CoCrPt—SiO2 layer is a lowermost layer, there is little change when thickness increases. However, in the case of the present example in which the CoPt—TiO2 layer is a lowermost layer, when the thickness of the CoPt—TiO2 layer having a high magnetic anisotropic energy Ku increases, the nucleation field Hn or coercive force Hc of the recording layer increases drastically.

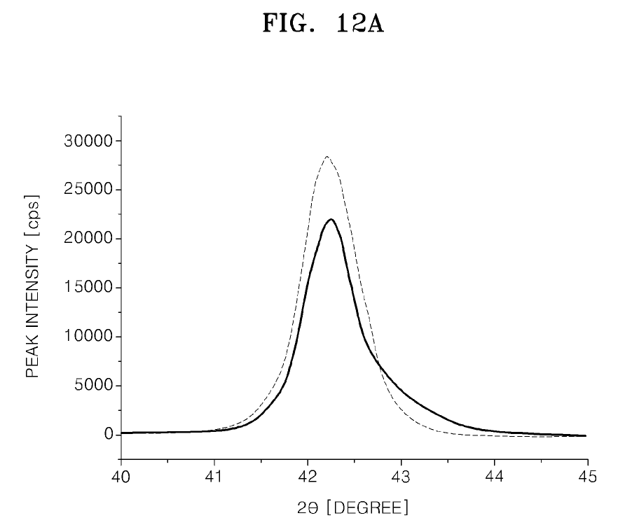

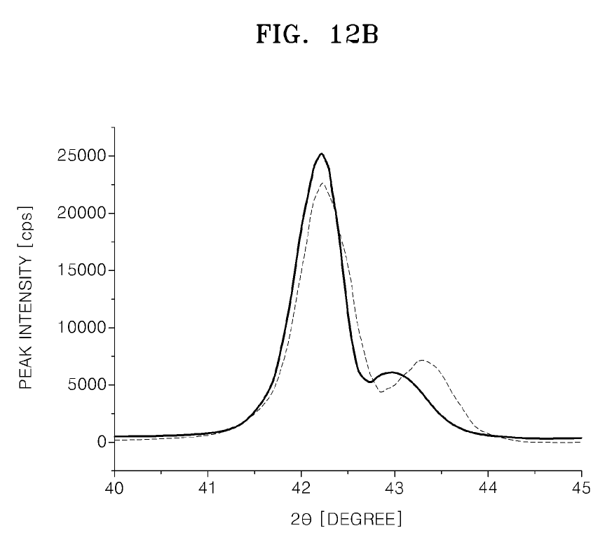

FIGS. 12A and 12B are graphs illustrating X-ray diffraction (XRD) analysis results when Co alloy oxide layers of a recording layer are stacked in different orders. In FIG. 12A, a sold line represents a present example in which a recording layer is formed by sequentially stacking a CoPt—TiO2 layer, a CoCrPt—SiO2 layer, and a CoCrPtB layer, and a dotted line represents a comparative example in which a recording layer is formed by sequentially stacking a CoPt—TiO2 layer and a CoCrPtB layer. In FIG. 12B, a solid line represents a comparative example in which a recording layer is formed by sequentially stacking a CoCrPt—SiO2 layer, a CoPt—TiO2 layer, and a CoCrPtB layer, and a dotted line represents a comparative example in which a recording layer is formed by sequentially stacking a CoCrPt—SiO2 layer and a CoCrPtB layer.

Referring to FIG. 12A, in the case of the comparative example in which the recording layer has a CoPt—TiO2/CoCrPt—SiO2 structure with the CoPt—TiO2 layer as a lowermost, a peak corresponding to a Co(002) plane is observed in the vicinity of the of a CoPt—TiO2 single layer. Referring to FIG. 12B, in the case of the comparative example in which the recording layer has a CoCrPt—SiO2/CoPt—TiO2 structure with the CoCrPt—SiO2 layer as a lowermost layer, a peak is observed in the vicinity of a CoCrPt—SiO2 single layer.

It can be seen from FIGS. 12A and 132B that crystal orientation, that is, a crystal plane distance change, which greatly affects magnetic characteristics, is very sensitive to the orders in which the Co alloy oxide layers are stacked. In particular, in order to obtain the original crystal characteristics and magnetic characteristics of the CoPt—TiO2 layer, it is necessary that the CoPt—TiO2 layer should be a lowermost layer and the CoCrPt—SiO2 layer should be stacked on the CoPt—TiO2 layer like in the present example. That is, referring to FIGS. 12A and 12B, when the CoPt—TiO2 layer is a lowermost layer and then the CoCrPt—SiO2 layer is stacked on the CoPt—TiO2 layer, crystal orientation can be improved and a magnetic anisotropic energy Ku can be improved. This is because when the CoPt—TiO2 layer having a larger distance between atoms in a crystal plane parallel to a substrate is a lowermost layer and the CoCrPt—SiO2 layer having a smaller distance between atoms in a crystal plane parallel to the substrate is stacked on the CoPt—TiO2 layer, crystal orientation can be improved and the magnetic anisotropic energy Ku of the recording layer can be improved.

Furthermore, the recording layer according to the present invention may include a plurality of ferromagnetic layers. In this case, when each layer of the plurality of ferromagnetic layers has a magnetic anisotropic energy Ku which decreases as distance increases from an underlayer, the magnetic anisotropic energy Ku of the recording layer can be improved. This is because when a layer having a larger distance between atoms in a crystal surface parallel to the substrate is formed as a lower layer, crystal orientation can be improved and the magnetic anisotropic energy Ku of the recording layer can be improved. Also, as a Pt concentration increases, a magnetic anisotropic energy Ku increases. Accordingly, when each layer of the plurality of ferromagnetic layers have a Pt concentration which decreases as distance increases from the underlayer, a higher magnetic anisotropic energy Ku can be obtained.

Although the recording layer uses the hexagonally-close-packed (HCP) CoPt—TiO2 layer as a lower ferromagnetic layer, even though an FePt alloy, an FePt alloy oxide, a CoPt alloy, or a CoPt alloy oxide having a larger distance between atoms in a crystal surface parallel to a substrate is used as a lower ferromagnetic layer and a CoCrPt-oxide layer is used as an upper ferromagnetic layer, high effect can be obtained. Moreover, although each of the first and second ferromagnetic layers 161 and 163 has a double-layer structure, the first and second ferromagnetic layers 161 and 163 may include three or more layers. In this case, each of the plurality of ferromagnetic layers may have a magnetic anisotropic energy Ku which decreases as distance increases from the underlayer 150

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording medium comprising:
a substrate;
a plurality of soft magnetic layers comprising a lower soft magnetic layer and an upper soft magnetic layer which are sequentially stacked on the substrate, wherein the upper soft magnetic layer has an anisotropic field greater than that of the lower soft magnetic layer;
an isolating layer interposed between the lower and upper soft magnetic layers and preventing magnetic interaction between the lower and upper soft magnetic layers;
an underlayer formed on the plurality of soft magnetic layers; and
a recording layer formed on the underlayer and comprising a plurality of ferromagnetic layers, each layer of which has a different magnetic anisotropic energy which decreases as distance increases from the underlayer.

2. The perpendicular magnetic recording medium of claim 1, wherein each ferromagnetic layer of the plurality of ferromagnetic layers has a different Pt concentration which decreases as a distance increases from the underlayer.

3. The perpendicular magnetic recording medium of claim 1, wherein the plurality of ferromagnetic layers comprise first and second ferromagnetic layers sequentially stacked on the underlayer,
wherein the first ferromagnetic layer is formed of any one selected from the group consisting of an FePt alloy, an FePt alloy oxide, a CoPt alloy, and a CoPt alloy oxide, and the second ferromagnetic layer is formed of a CoCrPt alloy oxide.

4. The perpendicular magnetic recording medium of claim 3, wherein the second ferromagnetic layer has a Pt concentration which is less than a Pt concentration of the first ferromagnetic layer.

5. The perpendicular magnetic recording medium of claim 3, wherein each of the first and second ferromagnetic layers has a granular structure.

6. The perpendicular magnetic recording medium of claim 5, wherein the second ferromagnetic layer has a granular structure in which grains formed of a Co alloy are magnetically separated from one another and an oxide is interposed between the grains.

7. The perpendicular magnetic recording medium of claim 1, wherein the recording layer further comprises a capping layer disposed on the plurality of ferromagnetic layers.

8. The perpendicular magnetic recording medium of claim 7, wherein the capping layer is a continuous thin film formed of a Co alloy where grains are not separated from one another.

9. The perpendicular magnetic recording medium of claim 8, wherein the capping layer is formed of CoCrPtB.

10. The perpendicular magnetic recording medium of claim 1, wherein the underlayer is formed of Ru and oxygen.

11. The perpendicular magnetic recording medium of claim 10, wherein the underlayer comprises:
a first underlayer which is formed of Ru; and
a second underlayer which is formed of Ru and oxygen and is disposed on the first underlayer,
wherein grains contained in the second underlayer are formed of Ru, and oxygen is interposed between the grains.

12. The perpendicular magnetic recording medium of claim 1, wherein the isolating layer is formed of a non-magnetic metal material or a non-magnetic non-metal material.

13. The perpendicular magnetic recording medium of claim 1, wherein the upper soft magnetic layer comprises:
a plurality of unit soft magnetic layers; and
at least one non-magnetic spacer which is interposed between the plurality of unit soft magnetic layers so that the upper soft magnetic layer has an Ruderman-Kittel-Kasuya-Yosida coupling structure.

14. The perpendicular magnetic recording medium of claim 1, further comprising a magnetic domain control layer which is disposed under the upper soft magnetic layer so that the upper soft magnetic layer has a high anisotropic field.

15. The perpendicular magnetic recording medium of claim 14, wherein the magnetic domain control layer is formed of an antiferromagnetic material or a ferromagnetic material.

16. The perpendicular magnetic recording medium of claim 1, wherein the upper soft magnetic layer is thinner than the lower soft magnetic layer.

17. The perpendicular magnetic recording medium of claim 1, wherein the lower and upper soft magnetic layers are formed of a same magnetic material.

18. The perpendicular magnetic recording medium of claim 1, wherein the upper soft magnetic layer is formed of any one selected from the group consisting of CoZrNb, CoZrTa, a FeTa alloy, and a FeCo alloy.

19. The perpendicular magnetic recording medium of claim 1, wherein the lower soft magnetic layer is formed of any one selected from the group consisting of a NiFe alloy, CoZrNb, CoZrTa, a FeTa alloy, and a FeCo alloy.

20. The perpendicular magnetic recording medium of claim 1, further comprising a buffer layer which is interposed between the plurality of soft magnetic layers and the underlayer, and suppresses magnetic interaction between the soft magnetic layers and the recording layer.
